(19) United States
(12) Patent Application Publication
(10) Pub. No.: US 2005/0073856 A1
(43) Pub. Date: Apr. 7, 2005

(54) Light diffuser plate and liquid crystal displays using the same

(75) Inventors: Young Oh, Incheon-shi (KR); Sung Kook Kim, Gyeonggi-do (KR); Chul Bum Park, Toronto (CA)

Correspondence Address: Maria Parrish Tungol, Suite 100, 5820 Fifer Drive, Alexandria, VA, 22303, US

(73) Assignee: Cheil Industries Inc., Kyungbuk (KR)

(21) Appl. No.: 10/927,512

(22) Filed: Aug. 27, 2004

(30) Foreign Application Priority Data
Aug. 27, 2003 (KR) 2003-59404

(51) Int. Cl. H01P 5/00

(52) U.S. Cl. 362/558

(57) ABSTRACT

A light diffuser plate for liquid crystal displays according to the present invention is prepared with a thermoplastic resin composition comprising (A) a matrix selected from the group consisting of methacrylic resin, styrenic resin, cyclic olefinic resin, polyester resin, and a mixture thereof, and (B) a polycarbonate resin admixed in the matrix as a light diffusing agent. The amount of polycarbonate resin (B) is about 0.01˜20% by weight based on the weight of the plate and preferably has an average particle diameter of about 0.01˜20 μm.

### FIELD OF THE INVENTION

The present invention relates to a light diffuser plate for liquid crystal displays. More particularly, the present invention relates to a light diffuser plate that is prepared with a thermoplastic resin composition through which light is transmitted or diffused, and liquid crystal displays employing the light diffuser plate.

### BACKGROUND OF THE INVENTION

A light diffuser plate prepared with a thermoplastic resin composition is employed under the liquid crystal panel of liquid crystal displays (LCD) to transmit or diffuse the lights from a light source. The LCD panel contains a layer of hundreds of thousands of liquid crystal cells placed between layers of polarized glass. Light from a powerful light source in the back of the panel moves first through the light diffuser plate which distributes the light evenly across the screen.

The light then passes through a layer of thin film transistors (TFT) plus color filters which control the amount of electricity passed into each liquid crystal cell. The result is hundreds of thousands of LCD pixels, each generating red, blue, or green color to provide the final color images.

The thermoplastic resin compositions typically used to produce the light diffuser plate are known in the art and include methacrylic resin, styrenic resin, cyclic olefinic resin, polycarbonate resin, polyester resin and the like. For example, PCT Publication No. WO 01/96451 A1 discloses a biaxially oriented polyester film for the light diffuser plate.

When the light diffuser plate is prepared, a light diffusing agent is conventionally added to the base resin, hereafter referred to as the matrix. If the light diffusing agent is not employed in the matrix, the light transmittance and light diffusion of the light diffuser plate is not sufficient. In other words, a light diffusing agent is added to the matrix of a light diffuser plate to result in high transmittance rate of the direct lights or fluorescent lights as well as in good diffusion of the lights so that the light source may not be identified by human eyes.

Inorganic particles are typically used as conventional light diffusing agent in the preparation of the light diffuser plate. Examples of the inorganic particles are calcium carbonate, barium sulfate, titanium dioxide, aluminum hydroxide, silica, glass, talc, mica, white carbon, magnesium oxide, zinc oxide and the like.

In the preparation of a conventional thermoplastic resin composition for the light diffuser, a light diffusing agent having a difference of about 0.02˜0.13 in the index of refraction from the base resin is used to improve the light transmittance rate and light diffusion.

For example, Japanese Patent Publication No. 6-107939 discloses a polycarbonate resin composition which comprises about 100 parts by weight of polycarbonate, about 0.1˜5.0 parts by weight of calcium carbonate coated with alkyl ketene dimers, and about 0.01˜0.5 parts by weight of zinc sulfide and/or titanium oxide. And, Japanese Patent Publication No. 6-306266 discloses a polycarbonate resin composition in which polycarbonate is used as base resin or matrix and barium sulfate or titanium oxide as light diffusing agent.

However, in the light diffuser plates as disclosed in the Japanese patent applications above, there exists a problem with uneven spots when the lights are transmitted or diffused through the light diffuser plate because the large and small particles in the resin composition are agglomerated.

Further, when an inorganic material is used as a light diffuser agent, the inorganic particles are not homogeneously admixed in the matrix of a thermoplastic resin composition, and the apparatus for preparation of the light diffuser plate such as die line can be damaged due to the hardness of the inorganic material.

Accordingly, the present inventors have developed a new resin composition for the light diffuser plate of liquid crystal displays, which comprises a matrix selected from methacrylic resin, styrenic resin, cyclic olefinic resin, polyester resin, and a mixture thereof, and polycarbonate resin as light diffusing agent so as to overcome the disadvantages of the conventional resin compositions for the light diffuser plate.

### SUMMARY OF THE INVENTION

A light diffuser plate for liquid crystal displays according to the present invention is prepared with a thermoplastic resin composition comprising (A) a matrix selected from the group consisting of methacrylic resin, styrenic resin, cyclic olefinic resin, polyester resin, and a mixture thereof, and (B) a polycarbonate resin admixed in the matrix as a light diffusing agent.

The polycarbonate resin (B) is preferably used in an amount of about 0.01˜20% by weight based on the weight of the light diffuser plate and has preferably an average particle diameter of about 0.01˜20 μm.

A feature of the present invention is the provision of an excellent light diffuser plate for liquid crystal displays. The light diffuser plate is employed to prepare liquid crystal displays with good light transmittance and light diffusion.

Another feature of the present invention is the provision of a light diffuser plate with good light transmittance and light diffusion.

A further feature of the present invention is the provision of a light diffuser plate with good light stability.

A further feature of the present invention is the provision of a light diffuser plate in which a light diffusing agent is homogeneously admixed in the resin composition.

A further feature of the present invention is the provision of a light diffuser plate which does not damage the apparatus during the preparation process.

A further feature of the present invention is the provision of a light diffuser plate which is prepared with a lower manufacturing cost.

A further feature of the present invention is the provision of a liquid crystal display with good light transmittance and light diffusion.

Other features and advantages of this invention will be apparent from the ensuing disclosure and appended claims.

### DETAILED DESCRIPTION OF THE INVENTION

As discussed previously, transparent thermoplastic resins such as polycarbonate resin, methacrylic resin, styrenic resin, cyclic olefinic resin, polyester resin, or the like have been used to produce light diffuser plates for use under the liquid crystal panel of liquid crystal displays to transmit and diffuse the lights from a light source. In particular, polycarbonate resin has been used as a matrix (or a base resin) for preparing the light diffuser plate.

A major feature of the present invention is to use polycarbonate as a light diffusing agent but not as a matrix. When the polycarbonate resin is used as a light diffusing agent in the light diffuser plate, the plate shows superior light diffusion, transmittance and stability compared to the light diffuser plate using a conventional inorganic material as a light diffusing agent. When used as the light diffusing agent instead of the inorganic material of the prior art, polycarbonate is homogeneously admixed in the resin composition and does not damage the apparatus during the preparation process. Further, as polycarbonate resin is cheaper than inorganic material, the manufacturing costs can be reduced.

(A) Matrix (Base Resin)

The matrix for preparing the light diffuser plate according to the present invention is a non-polycarbonate transparent thermoplastic resin. The matrix is comprised of methacrylic resin, styrenic resin, cyclic olefinic resin, polyester resin, or a mixture thereof. Transparent thermoplastic resins that can be used in the present invention are known in the art. Japanese Laid-Open Application No. 9-268203, herein incorporated by reference, discloses a method of preparing methacrylic resin suitable for use in a light diffuser plate.

The matrix can be a homopolymer or copolymer resin. When the matrix is a copolymer, it is preferable that the matrix contains less than about 50% by weight of a monofunctional unsaturated comonomer component, more preferably, less than about 30% by weight, and most preferably, less than about 20% by weight. Examples of the monofunctional unsaturated comonomer component are acrylic acid esters, unsaturated acid compounds with methacrylic acid or acrylic acid, styrenes, acrylonitriles, anhydride maleic acids, phenyl maleic imides, cyclohexyl maleic imides and the like. The acrylic acid esters include methacrylic acid ethyl, methacrylic acid butyl, methacrylic acid cyclohexyl, methacrylic acid benzyl, methacrylic acid 2-ethyl hexyl, methacrylic acid 2-hydroxy ethyl, methacrylic acid phenyl, methacrylic acid chlorophenyl, acrylic acid methyl, acrylic acid ethyl, acrylic butyl, acrylic acid cyclohexyl, acrylic acid benzyl, acrylic acid 2-ethyl hexyl, or acrylic acid 2-hydroxy ethyl.

Examples of methacrylic resin include, but are not limited to, poly(methylmethacrylate), methacrylic acid methyl-acrylic acid methyl copolymers, (meth)acrylate-styrene copolymers, and other copolymers of methacrylic acid methyl with the above monofunctional unsaturated comonomers. Examples of styrenic resin include, but are not limited to, polystyrene, styrene-α-methylstyrene copolymer, styrene-vinyltoluene copolymer, copolymers of styrenic monomers with other polymerizable monomers such as (meth)acrylic monomers, maleic anhydride, maleimide monomers and the above monofunctional unsaturated comonomers.

Examples of cyclic olefin resin include, but are not limited to, homo- or copolymers of vinylcycloalkane monomers such as vinylcyclopentane, vinylcyclohexane, vinylcycloheptane, α-methyl vinylcyclohexane, vinylmethyl cyclohexane, vinylbutyl cyclohexane; vinylcycloalkene monomers such as vinylcyclopentene, vinylcyclohexene, vinylmethylcyclohexene, vinylcycloheptene; and norbornane ring-containing (meth)acrylate.

Polyester resins suitable for use as a matrix for use in a light diffusing plate are known in the art. For example, PCT Publication No. WO 01/96451 A1, herein incorporated by reference, discloses polyester resins which can be used as a matrix for a light diffuser plate. Examples of polyester resins include, but are not limited to, polyethylene terephthalate and polybutylene terephthalate and the like.

It is preferable that the light diffuser plate contains about 80.0˜99.99% by weight of the transparent matrix resin. A mixture among methacrylic resin, styrenic resin and cyclic olefinic resin, and polyester resin can be used as the matrix in this invention. Preferably, a methacrylic acid methyl resin with the light transmittance rate greater than 90% may be used.

A methacrylic, styrenic, or cyclic olefinic copolymer containing at least two of the following monomers may be used as a matrix in the present invention: acrylic acid esters, unsaturated acid compounds with methacrylic acid or acrylic acid, styrenes, acrylonitriles, anhydride maleic acids, phenyl maleic imides, cyclohexyl maleic imides and the like. The acrylic acid esters include methacrylic acid ethyl, methacrylic acid butyl, methacrylic acid cyclohexyl, methacrylic acid benzyl, methacrylic acid 2-ethyl hexyl, methacrylic acid 2-hydroxy ethyl, methacrylic acid phenyl, methacrylic acid chlorophenyl, acrylic acid methyl, acrylic acid ethyl, acrylic butyl, acrylic acid cyclohexyl, acrylic acid benzyl, acrylic acid 2-ethyl hexyl, or acrylic acid 2-hydroxy ethyl.

(B) Polycarbonate Resin Light Diffusing Agent

In the light diffuser plate according to the present invention, polycarbonate resin is employed as the light diffusing agent. As polycarbonate resin has good transmittance and heat resistance, it has an excellent effect as light diffusing agent for the light diffuser plate. Further, unlike the conventional light diffusing agents such as inorganic particles, the polycarbonate resin can be homogeneously admixed in the matrix.

The average particle size of polycarbonate resin may be varied depending on the amount thereof. Preferably the polycarbonate resin with an average particle diameter of about 0.01˜20 μm may be used in the present invention.

It is preferable to use a polycarbonate resin with a viscosity average molecular weight of about 10,000˜100,000, and more preferably about 15,000˜40,000. In order to control the viscosity of the polycarbonate resin, a molecular weight controlling agent and/or a catalyst may be added in a known manner determined by skilled persons in the art.

The polycarbonate resin used in the present invention is known in the art and can be prepared by methods known in the art, e.g., the method disclosed in Korean Laid-Open Application No. 2000-5892, herein incorporated by reference. The polycarbonate resin may be prepared through a phosgene process of reacting phosgene with various dihydroxy diaryl compounds, or through an ester exchange process of reacting ester carbonate such as diphenyl carbonate with a dihydroxy diaryl compound.

A representative example of the dihydroxy diaryl compound is 2,2-bis-(4-hydroxyphenyl)-propane called ‘bisphenol A’. Other examples of the dihydroxy diaryl compound are bis-(hydroxy aryl) alkanes such as bis-(4-hydroxyphenyl)-methane, 1,1-bis-(4-hydroxyphenyl)-ethane, 2,2-bis-(4-hydroxyphenyl)-butane, 2,2-bis-(4-hydroxyphenyl)-octane, 2,2-bis-(4-hydroxyphenyl 3-methyl phenyl)-propane, 1,1-bis-(4-hydroxy 3-tert-butyl phenyl)-propane, 2,2-bis-(4-hydroxy 3-bromo phenyl)-propane, 2,2-bis-(4-hydroxy 3,5-dibromo phenyl)-propane, and 2,2-bis-(4-hydroxy 3,5-dichloro phenyl)-propane; bis-(hydroxy aryl) cycloalkanes such as 1,1-bis-(4-hydroxyphenyl)-cyclopenthane and 1,1-bis-(4-hydroxyphenyl)-cyclohexane; dihydroxy diaryl ethers such as 4,4′-dihydroxy diphenyl ether and 4,4′-dihydroxy 3,3′-dimethyl diphenyl ether; dihydroxy diaryl sulfides such as 4,4′-dihydroxy diphenyl sulfide; dihydroxy diaryl sulfoxides such as 4,4′-dihydroxy diphenyl sulfoxide and 4,4′-dihydroxy 3,3′-dimethyl diphenyl sulfoxide; and dihydroxy diaryl sulphones such as 4,4′-dihydroxy diphenyl sulphone and 4,4′-dihydroxy 3,3′-dimethyl diphenyl sulphone. The dihydroxy diaryl compounds may be used separately or in a mixture.

The polycarbonate resin according to the present invention may include a phenol with multiple substituents in addition to the dihydroxy diaryl compound. Representative examples of such phenols are 4,6-dimethyl 2,4,6-tri-(4-hydroxy phenyl)-heptene, 2,4,6-trimethyl 2,4,6-tri-(4-hydroxy phenyl)-heptene, 1,3,5-tri-(4-hydroxy phenyl)-benzene, 1,1,1-tri-(4-hydroxy phenyl)-ethane, and 2,2-bis-[4,4-(4,4′-dihydroxy diphenyl)-cyclohexyl]-propane. The phenol may be used separately or in a mixture.

The amount of polycarbonate resin is about 0.01˜20% by weight based on the weight of the plate. The amount of the polycarbonate as light diffusing agent depends on the thickness of the light diffuser plate film. If the thickness is less than about 1 mm, the amount of polycarbonate resin is about 10˜20% by weight in the matrix, and if the thickness is about 1 to 10 mm, the amount is about 0.1˜10% by weight, and if the thickness is more than about 10 mm, the amount is about 0.01˜0.1% by weight. When the light diffuser plate is thick, the length for the light to pass becomes longer, and the transmittance of lights decreases but the diffusion of lights increases. Accordingly, in such light diffuser plate, a small amount of the light diffusing agent is used. On the other hand, when the light diffuser plate is thin, the length for the light to pass becomes shorter, and the transmittance of light increases but the diffusion of light decreases. Accordingly, in such light diffuser plate, a large amount of the light diffusing agent is used.

Although determination of the amount of the polycarbonate as light diffusing agent depends on the thickness of the light diffuser plate film, it has been generally observed that if the amount of polycarbonate resin is less than about 0.01% by weight, the light source will be reflected because of the low dispersion of lights. On the other hand, it has been generally observed that if the amount of polycarbonate resin is more than about 20% by weight, the transparency will be reduced because of the low transmittance of light.

To improve the physical and chemical properties of the light diffuser plate according to the present invention, other additives may be added in the matrix. For example, a benzophenone or a benzotriazole may be added as an ultraviolet absorbent, and a hindered amine may be used as a light stabilizing agent. To resolve an appearance problem of a yellowish phenomenon due to degradation of the resin, a blowing agent may be used in the matrix. Further, the matrix may optionally contain other additives such as a plasticizer, an antioxidant, a heat stabilizer, a lubricant, a flame retardant, a filler, a releasing agent, a dye, an antifungi agent, an antidropping agent and the like.

The light diffuser plate according to the present invention is prepared by known molding processes for a thermoplastic resin such as injection molding, extrusion molding, heat press molding, or co-extrusion molding. The molding process may be selected by one skilled in the art depending on the specific use of the light diffuser plate.

The light diffuser plate of the present invention has good light transmittance, light diffusion, and light stability. In the light diffuser plate, the light diffusing agent is homogeneously admixed in the resin matrix. As the light diffuser plate has a lower hardness than that of a conventional light diffuser plate using an inorganic material as a light diffusing agent, it does not damage the apparatus during manufacturing processes such as the molding of the plate.

In particular, when the light diffuser plate of the present invention is applied to a liquid crystal display, the lights coming from the plural lamps transmit and diffuse the light diffuser plate in uniform brightness, therefore the lamps (light sources) located under the light diffuser plate are not reflected.

A liquid crystal display using the light diffuser plate according to the present invention is prepared by methods known in the art, for example, Korean Laid-open Application No. 2004-46640, herein incorporated by reference.

The invention may be better understood by reference to the following examples which are intended for the purpose of illustration and are not to be construed as in any way limiting the scope of the present invention. In the following examples, all parts and percentage are by weight unless otherwise indicated.

### EXAMPLES 1A-1D

Methacrylic acid methyl of 95% by weight and acrylic acid methyl of 5% by weight were copolymerized to prepare a transparent thermoplastic resin. To the thermoplastic resin were added 1, 3, 5 and 7% by weight of polycarbonate with an viscosity average molecular weight of about 30,000 as light diffusing agent to prepare 4 resin compositions of 1A to 1D. The four resin compositions were melted after heating, and molded with a square mold of 6″×6″ to prepare four specimens of the light diffuser plates with a thickness of ⅙″.

### COMPARATIVE EXAMPLES 1A-1D

Comparative Examples 1A-1D were conducted in the same manner as in Examples 1A-1D except that 1, 3, 5 and 7% by weight of calcium carbonate with particle sizes of about 1.8 to 2.0 μm were used as as light diffusing agent.

### COMPARATIVE EXAMPLES 2A-2D

Comparative Examples 2A-2D were conducted in the same manner as in Examples 1A-1D except that 1, 3, 5 and 7% by weight of barium sulphate with particle sizes of about 4.0 μm were used as as light diffusing agent.

The specimens prepared in the Examples above were tested with a hazemeter (Σ80: a product of Japanese Electrocolor Industry Co., Ltd.), and the light transmittance rate and dispersion were shown in Table 1.

TABLE 1

| | | Transmittance | Dispersion |
|---|---|---|---|
| Examples | 1A | 73.41 | 93.12 |
| | 1B | 58.25 | 93.81 |
| | 1C | 51.92 | 94.10 |
| | 1D | 47.31 | 94.07 |
| Comparative | 1A | 68.81 | 92.29 |
| Examples | 1B | 55.20 | 93.39 |
| | 1C | 48.11 | 93.50 |
| | 1D | 43.47 | 93.49 |
| | 2A | 66.84 | 92.28 |
| | 2B | 55.96 | 93.14 |
| | 2C | 48.12 | 93.49 |
| | 2D | 44.68 | 93.01 |

As shown in the Table 1, the light transmittance and dispersion of Examples 1A-1D are remarkably higher than those of Comparative Examples 1A-1D and 2A-2D.

Many modifications and changes may be deemed to be with the scope of the present invention.

1. A light diffuser plate for liquid crystal displays wherein the light diffuser plate is comprised of a thermoplastic resin composition comprising (A) a matrix selected from the group consisting of methacrylic resin, styrenic resin, cyclic olefinic resin, polyester resin, and a mixture thereof, and (B) a polycarbonate resin admixed in the matrix as a light diffusing agent wherein the amount of polycarbonate resin is about 0.01˜20% by weight based on the weight of the plate.

2. The light diffuser plate according to claim 1, wherein the matrix is a homopolymer.

3. The light diffuser plate according to claim 1, wherein the matrix is a copolymer which contains less than about 50% by weight of a monofunctional unsaturated comonomer component.

4. The light diffuser according to claim 1 wherein the polycarbonate resin has an average particle diameter of about 0.01˜20 μm.

5. The light diffuser plate according to claim 1 wherein the thickness of the light diffuser plate is less than about 1 mm and the amount of polycarbonate resin is about 10˜20% by weight based on the weight of the plate.

6. The light diffuser plate according to claim 1 wherein the thickness of the light diffuser plate is about 1 to 10 mm and the amount of polycarbonate resin is about 0.1˜10% by weight based on the weight of the plate.

7. The light diffuser plate according to claim 1 wherein the thickness of the light diffuser plate is more than about 10 mm and the amount of polycarbonate resin is about 0.010.1% by weight based on the weight of the plate.

8. The light diffuser plate according to claim 1 wherein the matrix is a methacrylic acid methyl resin.

9. The light diffuser plate according to claim 1 wherein the methacrylic acid methyl resin has a light transmittance rate greater than 90%.

10. A liquid crystal display comprising the light diffuser plate of claim 1.

11. A liquid crystal display comprising the light diffuser plate of claim 2.

12. A liquid crystal display comprising the light diffuser plate of claim 3.

13. A liquid crystal display comprising the light diffuser plate of claim 4.

14. A liquid crystal display comprising the light diffuser plate of claim 5.

15. A liquid crystal display comprising the light diffuser plate of claim 6.

16. A liquid crystal display comprising the light diffuser plate of claim 7.

17. A liquid crystal display comprising a light source, the light diffuser plate of claim 1, and a liquid crystal display panel.

18. A light diffuser plate for liquid crystal displays wherein the light diffuser plate is comprised of a thermoplastic resin composition comprising (A) a matrix selected from the group consisting of methacrylic resin, styrenic resin, cyclic olefinic resin, polyester resin, and a mixture thereof, and (B) a light diffusing agent admixed in the matrix wherein the light diffusing agent consists essentially of a polycarbonate resin in an amount of about 0.01˜20% by weight based on the weight of the plate.

19. A light diffuser plate for liquid crystal displays wherein the light diffuser plate is comprised of a thermoplastic resin composition comprising (A) a matrix comprising methacrylic acid methyl resin having a light transmittance rate greater than 90% and (B) a light diffusing agent admixed in the matrix wherein the light diffusing agent consists essentially of a polycarbonate resin in an amount of about 0.01˜20% by weight based on the weight of the plate.
